(19) United States
(12) Patent Application Publication
(10) Pub. No.: US 2015/0291211 A1
(43) Pub. Date: Oct. 15, 2015

(54) DEVICE FOR PROTECTING AGAINST OVERLOADING

(71) Applicant: Dr. Ing. h.c.F. Porsche Aktiengesellschaft, Stuttgart (DE)

(72) Inventors: Werner HASENMAIER, Renningen (DE); Michael SCHERZER, Ludwigsburg (DE); Andreas MÜLLER, Karlsruhe (DE); Stephan SALBER, Waldenbuch (DE)

(21) Appl. No.: 14/681,562

(22) Filed: Apr. 8, 2015

(30) Foreign Application Priority Data
Apr. 15, 2014 (DE) 102014105372.9

(51) Int. Cl. B62D 7/20; F16C 11/06

(52) U.S. Cl. CPC B62D 7/20; F16C 11/0623

(57) ABSTRACT

A device for protecting against the overloading of a steering gear and/or of a track rod in a steering system of a motor vehicle. An overload protection device which allows the possibility of yielding adjustment if there are relatively high compression and/or tension forces on the vehicle wheel is provided between a track rod and an axial joint of a steering system, with the result that damage to the steering system is avoided and reliable feedback can take place to the driver.

### CROSS-REFERENCE TO RELATED APPLICATIONS

This application claims priority under 35 U.S.C. §119 of German Patent Application No. 10 2014 105372.9, filed Apr. 15, 2014, which is incorporated by reference herein in its entirety.

### FIELD OF INVENTION

The invention relates to a device for protecting against the overloading of a steering gear, of a track rod connected to the steering gear and other components arranged in the same load path in a steering system of a motor vehicle.

### BACKGROUND

DE 29 20 637 A1, which is incorporated by reference herein, discloses a device having a yielding force transmission member between a track lever and a steering gear, which comes into effect when a maximum operational force is exceeded. DE 10 2008 064 401 A1, which is incorporated by reference herein, has furthermore disclosed an axial joint with a steering system of a motor vehicle, which has a ball head in a housing, said ball head being connected to a ball pin, and the ball head is arranged in a bearing shell with an overload bearing surface.

### SUMMARY

It is an object of the invention to provide overload protection for a track rod and adjoining components.

According to aspects of the invention, this object is achieved by a device for protecting against the overloading of a steering gear and of a track rod connected thereto in a steering system of a motor vehicle, wherein a yielding force transmission member is arranged between the track rod of the steering system and a ball head, connected to the steering gear, of an axial joint, the force transmission member forming an overload element in the presence of abnormally occurring compression and/or tension forces. Further advantageous embodiments in accordance with FIG. 1 are presented in the features of the other claims.

Overloads on a running gear assembly which significantly reduce the life of vital running gear components can be caused by unusual maneuvers. To avoid this, the corresponding components of the steering system are overdimensioned in order to ensure a design which is operationally robust. This leads to increased vehicle weight, and that is precisely what is to be avoided.

According to aspects of the invention therefore, the proposal is for a device which is embodied in what is referred to as lightweight construction and in which the operational robustness and functioning of the steering are fully maintained under an overload and reliable feedback to the driver can take place. According to aspects of the invention, this is achieved by arranging a yielding force transmission member between the track rod of the steering system and a ball head, connected to the steering gear, of an axial joint, said force transmission member forming an overload element in the presence of abnormally occurring compression and/or tension forces.

According to one embodiment of the invention, the force transmission member can be formed between the track rod, composed of cast aluminum, and a tubular sleeve, composed of steel, which are clamped together by shrink fitting, and the tubular sleeve of the axial joint or the ball head is connected to a stem of the ball head in the tubular sleeve by screwing. The track rod is in operative connection in the tension and/or compression direction, by means of cups press-fitted within the track rod, which form stops, on the one hand with a front end and, on the other hand, with a shoulder of the sleeve. By means of this embodiment, it is possible, in the case of forces acting abnormally on the wheel in the tension and/or compression direction, for displacement forces of the track rod to be adjusted by means of the force transmission member.

According to another embodiment of the invention, it is envisaged that the axial joint connected to the sleeve is held with a clamping action in press-fitted cups in a cylinder chamber of the track rod by means of a widened head arranged at the end of the sleeve and forms the force transmission member, wherein the bases of the cups each form a stop for the head in the tension and/or compression direction. By means of the widened head, which can be embodied as a screwed part or as a widened tube part or as a part turned in a stepped manner, a force transmission member with defined displacement forces in the case of abnormal tension and/or compression stresses is formed between the press-fitted cups in the track rod.

According to another embodiment of the invention, it is envisaged that the axial joint connected to the sleeve has, at the end of the sleeve, an expanded tube portion, which is arranged in a corresponding chamber in the track rod. At the end of the track rod of the cylindrical chamber, a threaded sleeve is arranged on the track rod end, overlapping from the outside. This threaded sleeve is adhesively bonded or microencapsulated to a threaded section of the track rod and forms the force transmission member, wherein the free end of the threaded sleeve comprises an annular flange which projects over the free end of the track rod and forms a stop. The annular flange of the threaded sleeve forms the stop with the expanded tube portion of the sleeve of the axial joint, while a further, opposite stop is formed by the base of the cylindrical chamber for the sleeve of the axial joint. In this embodiment, the force transmission member with defined displacement forces in the case of abnormal compressive and/or tensile stress is formed by a track rod held on the track rod by means of the threaded section. The corresponding threaded sections form what is referred to as a thread lock.

According to another embodiment of the invention, it is envisaged that the sleeve connected to the axial joint is held at one end in a cylindrical bore in the track rod in a clamping region of the track rod and forms the force transmission member, which consists of a plastically deformed section of the track rod on the sleeve of the axial joint. A stop is formed between the track rod and the sleeve of the axial joint between a stop step on the sleeve formed by an expanded plug and an opposite shoulder in the track rod, and a further, opposite stop is formed by the base of the cylindrical bore. In this embodiment, the track rod is plastically deformed in an end region, ensuring that the sleeve of the axial joint is held with a clamping action with a defined displacement force in the case of abnormally occurring tension and/or compression forces.

According to another embodiment of the invention, it is envisaged that the sleeve of the axial joint is connected in a slotted track rod, by way of a clamping action by means of a two-part adjusting element, and forms the force transmission member, wherein the adjusting element is held on the track rod by means of corresponding slot and key joints, and the clamping force of the adjusting element can be adjusted by means of mutual clamping by way of screw bolts. The adjusting element is arranged on a free end of the track rod and has an overlapping annular flange which, with an annular projection on the sleeve of the axial joint, forms a stop, and a further, opposite stop is formed on the inner surface of the track rod by an indentation. By means of this adjusting element on the force transmission member, a possibility for adjustment with integrated overload protection is created since the screwed joint can be tightened with control of the angle of rotation, for example.

According to another embodiment of the invention, the ball head of the axial joint can be arranged in a ball housing connected to the steering gear, and a guard against overloading can comprise an inserted element consisting of a honeycomb profile or a foamed material composed of aluminum, ceramic or steel. The element is preferably arranged between the ball head and the base of the ball housing. The overload protection device with the force transmission member in the track rod can be combined with the track-rod axial joint in accordance with the embodiments of the invention, for example. The element in the form of a crash structure can collapse above a certain peak load. Large kinematic misalignment can be caused by this, or knocking noises are to be expected during steering, making it possible to detect that the steering is faulty. In this embodiment, operational robustness (service life) and steerability are fully maintained. The element can be adapted to any limiting loads and vehicle types, and the deformation path of the element can also be set in a defined way.

An illustrative embodiment is shown in the drawings and is described in greater detail below.

### BRIEF DESCRIPTION OF THE DRAWINGS

In the drawings:

FIG. 1 shows a section through an axial joint, connected to a track rod, of a steering gear with a force transmission member in a first embodiment,

FIG. 2 shows a section through an axial joint, connected to a track rod, of a steering gear with a force transmission member in a second embodiment,

FIG. 3 shows a section through an axial joint, connected to a track rod, of a steering gear with a force transmission member in a third embodiment,

FIG. 4 shows a section through an axial joint, connected to a track rod, of a steering gear with a force transmission member in a fourth embodiment,

FIG. 5 shows a section through an axial joint, connected to a track rod, of a steering gear with a force transmission member in a fifth embodiment,

FIG. 5a shows a partial section through the two-part adjusting element according to FIG. 5,

FIG. 6 shows an axial joint with a crash element inserted into a ball housing, in a rest position, and

FIG. 7 shows the axial joint according to FIG. 6 when subjected to force in a retracted crash position.

### DETAILED DESCRIPTION

In a device for protection against overloading for a steering gear and a track rod 1 connected thereto in a steering system, a yielding force transmission member I; II; III; IV, V, which forms an overload element is arranged between the track rod 1 of the steering system and a ball head 2 connected to the steering gear by means of a tubular sleeve 4 of an axial joint 3. The track rod 1, the axial joint 3 and the sleeve 4 of the ball joint 2 of the various embodiments each have an identical item number below.

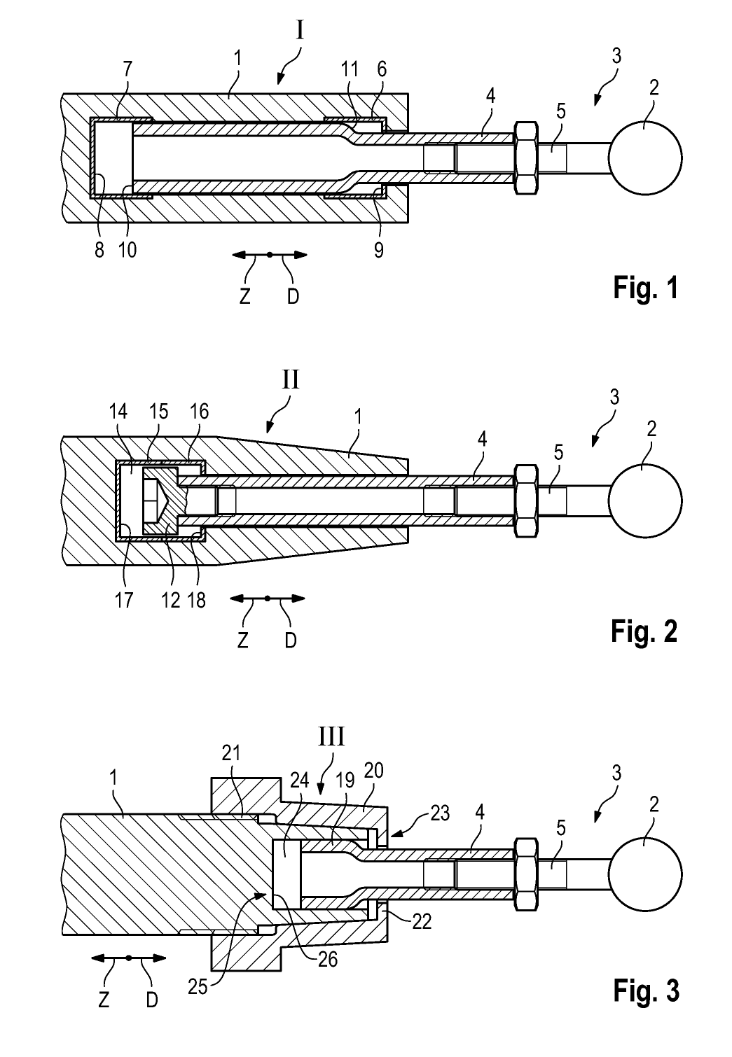

According to the first embodiment, shown in FIG. 1, the force transmission member I is formed between the track rod 1, composed of cast aluminum, and a tubular sleeve 4, composed of steel. The track rod 1 is clamped to the tubular sleeve 4 by what is referred to as a shrink-fitting process. The axial joint 3 or the ball head 2 is connected to a stem 5 of the ball head 2 in the tubular sleeve 4 by screwing.

The track rod 1 has stops 8 and 9 in the tension and/or compression direction Z and/or D within the track rod 1, in press-fitted cups 6 and 7, for a front end 10 and a shoulder 11 on the sleeve 4.

According to another embodiment, shown in FIG. 2, the axial joint 3 connected to the sleeve 4 is held with a clamping action in press-fitted cups 15, 16 in a cylinder chamber 14 of the track rod 1 by means of a widened head 12 arranged at the end of the sleeve 4, which is embodied as a screwed part, for example, and forms the force transmission member II. The bases of the cups 15, 16 each form a stop 17, 18 for the head 12 in the tension and compression direction Z and/or D.

According to another embodiment, shown in FIG. 3, the axial joint 3 connected to the sleeve 4 has, at the end of the sleeve 4, an expanded tube portion 19, which is arranged in a corresponding cylindrical chamber 24 in the track rod 1. At the free end of the track rod 1, a threaded sleeve 20 is arranged on the track rod end, overlapping the cylindrical chamber 24.

The threaded sleeve 20 is adhesively bonded, for example, to a threaded section 21 of the track rod 1 and forms the force transmission member III. The threaded sleeve 20 has an annular flange 22 which projects over the free end of the track rod 1 and forms a stop 23.

Said annular flange 22 of the threaded sleeve 20 forms a stop 23 with the expanded tube portion 19 of the sleeve 4 of the axial joint 3, and a further, opposite stop 25 is formed by the base 26 of the cylindrical chamber 24 for the sleeve 4 of the axial joint 3.

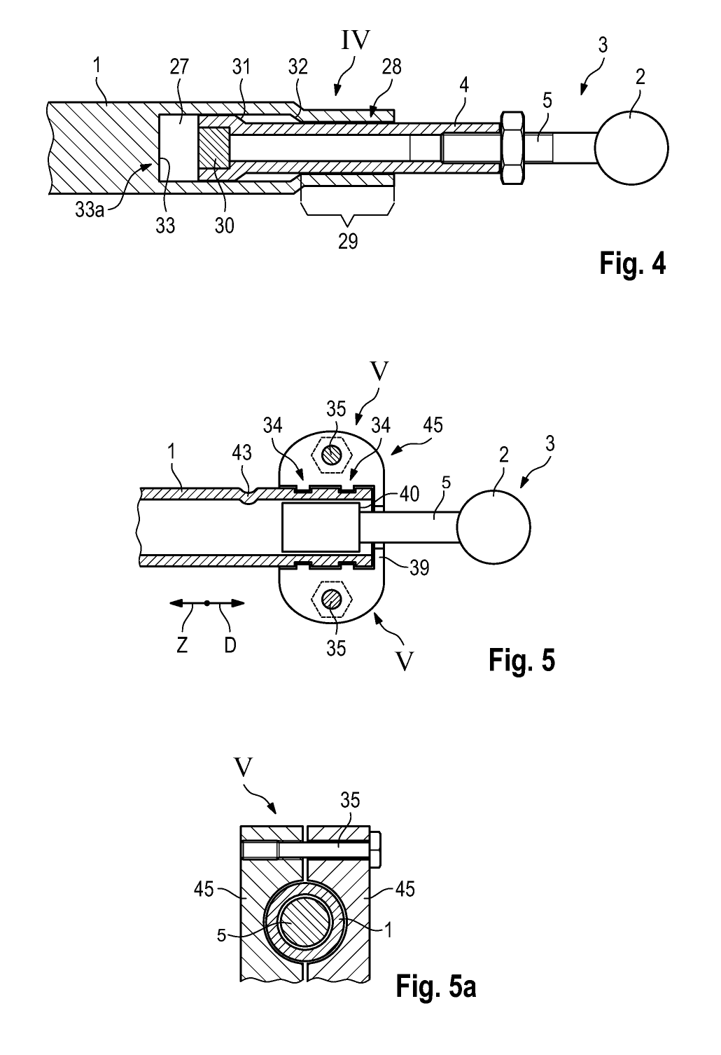

According to another embodiment, shown in FIG. 4, the sleeve 4 connected to the axial joint 3 via the stem 5 is held at one end in a cylindrical bore 27 of the track rod 1, in a clamping region 28 of the track rod 1, said region forming the force transmission member IV. Said clamping region 28 consists of a plastically deformed section 29 of the track rod 1 on the sleeve 4 of the axial joint 3.

An expanded plug 30 inserted into the sleeve is arranged between the track rod 1 and the sleeve 4 of the axial joint 3, forming a stop step 31 on the sleeve 4. A shoulder 32 in the track rod 1 forms a further, opposite stop 32. A further stop is furthermore formed by the base 33 of the cylindrical bore 27.

According to another embodiment, shown in FIGS. 5 and 5a, the stem 5 of the axial joint 3 is connected in a, preferably slotted, track rod 1, with a clamping action by means of a two-part adjusting element 45, forming the force transmission member V. Said adjusting element 45 is held on the track rod 1 by means of corresponding slot and key joints 34. The clamping force of the two-part adjusting element 45 can be adjusted by means of mutual clamping by way of screw bolts 35.

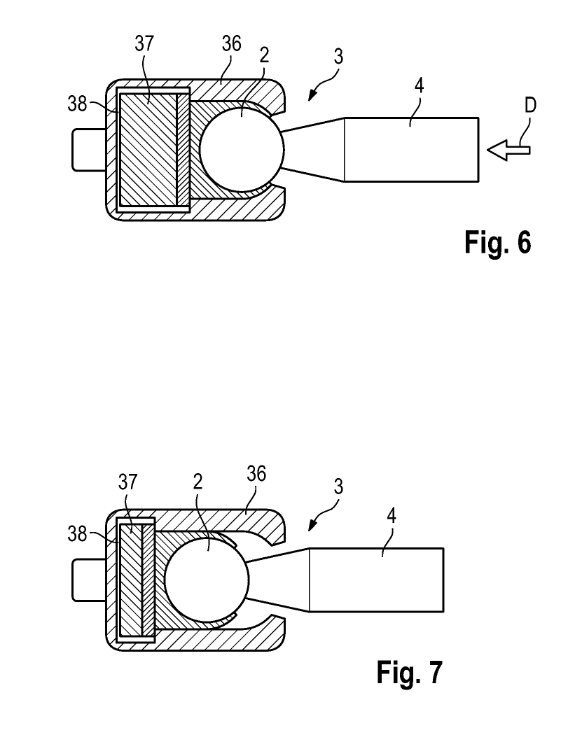

According to another embodiment of the invention, shown in FIGS. 6 and 7, which can be used in conjunction with the above embodiments of the invention, the ball head of the axial joint 3 is arranged in a ball housing 36 connected to the steering gear. To guard against overloading, an element consisting of a honeycomb profile or a foamed material composed of aluminum, ceramic or steel is inserted in the ball housing 36, said element collapsing at a particular overload, thus forming a protection against overloading after a limiting load is exceeded.

What is claimed:

1. A device for protecting against the overloading of a steering gear and of a track rod connected thereto in a steering system of a motor vehicle, wherein a yielding force transmission member (I; II; III; IV; V) is arranged between the track rod of the steering system and a ball head, connected to the steering gear, of an axial joint, said force transmission member forming an overload element in the presence of abnormally occurring compression and/or tension forces.

2. The device as claimed in claim 1, wherein the force transmission member (I) is formed between the track rod, composed of cast aluminum, and a tubular sleeve, composed of steel, which are clamped together by shrink fitting, and the tubular sleeve of the axial joint or the ball head is connected to a stem of the ball head by screwing.

3. The device as claimed in claim 1, wherein the track rod forms end stops in the tension and/or compression direction (Z, D) with cups press-fitted within the track rod by means of a front end and a shoulder of the sleeve.

4. The device as claimed in claim 1, wherein the axial joint connected to the sleeve is held with a clamping action in press-fitted cups in a cylinder chamber of the track rod by means of a widened head arranged at the end of the sleeve and forms the force transmission member (II), wherein the bases of the cups each form a stop for the head in the tension and/or compression direction (Z and/or D).

5. The device as claimed in claim 1, wherein the axial joint connected to the sleeve has, at the end of the sleeve, an expanded tube portion, which is arranged in a corresponding cylindrical chamber in the track rod, and, at the end of the track rod of the cylindrical chamber, a threaded sleeve is arranged on the track rod end, overlapping from the outside.

6. The device as claimed in claim 1, wherein the threaded sleeve is adhesively bonded or microencapsulated to a threaded section of the track rod and forms the force transmission member (III), wherein the free front end of the threaded sleeve comprises an annular flange which projects over the free end of the track rod and forms a stop.

7. The device as claimed in claim 1, wherein the annular flange of the threaded sleeve forms the stop with the expanded tube portion of the sleeve of the axial joint, and a further, opposite stop is formed by the base of the cylindrical chamber for the sleeve of the axial joint.

8. The device as claimed in claim 1, wherein the sleeve connected to the axial joint is held at one end on the track rod in a clamping region of the track rod and forms the force transmission member (IV), which consists of a plastically deformed section of the track rod on the sleeve of the axial joint.

9. The device as claimed claim 1, wherein a stop is formed between the track rod and the sleeve of the axial joint between a stop step on the sleeve formed by expansion by a plug and an opposite shoulder in the track rod, and a further, opposite stop is formed by the base of the cylindrical bore in the track rod.

10. The device as claimed in claim 1, wherein the stem of the axial joint is held in a slotted track rod, with a clamping action by means of a two-part adjusting element, forming the force transmission member (V), wherein the adjusting element is connected on the track rod by means of corresponding slot and key joints, and the clamping force of the adjusting element can be adjusted by means of mutual clamping by way of screw bolts.

11. The device as claimed in claim 1, wherein the adjusting element has an annular flange which fits over the free end of the track rod and, with an annular projection on the sleeve of the axial joint, forms a stop, and a further, opposite stop is formed on the inner surface of the track rod by an indentation.

12. The device as claimed in claim 1, wherein the ball head of the axial joint is arranged in a ball housing connected to the steering gear, and a guard against overloading comprises an element consisting of a honeycomb profile or a foamed material composed of aluminum, ceramic or steel, and the element is arranged between the ball head and the base of the ball housing.
